(19) United States
(12) Patent Application Publication
(10) Pub. No.: US 2026/0066439 A1
(43) Pub. Date: Mar. 5, 2026

(54) SECONDARY BATTERY AND METHOD FOR MANUFACTURING THEREOF

(71) Applicant: SAMSUNG SDI CO., LTD., Yongin-si (KR)

(72) Inventor: Taewoong JANG, Yongin-si (KR)

(21) Appl. No.: 19/019,906

(22) Filed: Jan. 14, 2025

(30) Foreign Application Priority Data
Sep. 4, 2024 (KR) 10-2024-0119891

(51) Int. Cl. H01M 50/317; H01M 50/188; H01M 50/552

(52) U.S. Cl. CPC H01M 50/317; H01M 50/188; H01M 50/552

(57) ABSTRACT

A secondary battery includes an electrode assembly, a case accommodating the electrode assembly, the case including an opening on one side thereof, a cap assembly seated in the opening of the case, the cap assembly including a vent hole penetrating the cap assembly in a first direction, and a sealing member in the vent hole, the sealing member including a degassing passage in the first direction.

### CROSS-REFERENCE TO RELATED APPLICATION

The present application claims priority to and the benefit of Korean Application No. 10-2024-0119891, filed on Sep. 4, 2024, in the Korean Intellectual Property Office, the entire disclosure of which is incorporated by reference herein.

### BACKGROUND

### 1. Field

The present disclosure is related to a secondary battery including a sealing member and a manufacturing method thereof.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

Abnormal phenomena may occur inside secondary batteries due to various reasons such as short circuits, leakage currents, etc. For example, abnormal phenomena may be abnormal temperature rise, gas generation by internal chemical reaction, explosion due to internal pressure increase, etc. Specifically, gas generated by the secondary batteries may cause fire, explosion, etc. in the secondary batteries. Therefore, it is important to remove the gas generated in the secondary batteries. It is required to design and develop secondary batteries that prevent the occurrence of abnormal phenomena and enhance stability even though abnormal phenomena occur.

The above information disclosed in this Background section is for enhancement of understanding of the background of the present disclosure, and therefore, it may contain information that does not constitute related (or prior) art.

### SUMMARY

According to embodiments of the present disclosure, there is provided a secondary battery, including an electrode assembly, a case accommodating the electrode assembly inserted through an opening formed on one side thereof, a cap assembly seated at the opening of the case and including a vent hole, wherein the vent hole penetrates the cap assembly in a first direction, and a sealing member inserted into the vent hole and including a degassing passage penetrated in the first direction.

According to embodiments, the case may accommodate an electrolyte with the electrode assembly, and the electrolyte may be injected through the degassing passage.

According to embodiments, the sealing member may be formed of an elastic material, and inserted in close contact with an inner diameter of the vent hole.

According to embodiments, the cap assembly may include a cap plate seated at and coupled to the opening of the case with a through-hole formed in the cap plate, a terminal plate including a body portion and an insertion portion protruding from the body portion and inserted into the through-hole of the cap plate, and an insulating layer disposed between the cap plate and the terminal plate.

According to embodiments, the secondary battery may further include an insulating washer disposed on one surface of the cap assembly facing the electrode assembly, and the insulating washer may cover the vent hole.

According to embodiments, the vent hole may include a first sub-vent hole formed by penetrating the terminal plate, a second sub-vent hole formed by penetrating the cap plate, and a third sub-vent hole formed by penetrating the insulating layer.

According to embodiments, the terminal plate may be coupled to the cap plate such that the insertion portion faces the electrode assembly.

According to embodiments, a diameter of the first sub-vent hole may be larger than a diameter of the second sub-vent hole and a diameter of the third sub-vent hole.

According to embodiments, the sealing member may include a head portion formed of a first diameter larger than a diameter of the second sub-vent hole and a diameter of the third sub-vent hole and a tail portion formed of a second diameter smaller than the first diameter, the head portion may be seated on at least one of the insulating layer and the cap plate.

According to embodiments, the terminal plate may be coupled to the cap plate such that the insertion portion is exposed to an outside through the through-hole of the cap plate and the body portion is disposed between the cap plate and the electrode assembly.

According to embodiments, a diameter of the second sub-vent hole may be larger than a diameter of the first sub-vent hole and a diameter of the third sub-vent hole.

According to embodiments, the sealing member may include a head portion formed of a third diameter larger than a diameter of the first sub-vent hole or a diameter of the third sub-vent hole, and a tail portion formed of a fourth diameter smaller than the third diameter, and the head portion may be seated on at least one of the insulating layer or the terminal plate.

According to embodiments, the vent hole may be formed by penetrating the body portion and the insertion portion.

According to embodiments, the vent hole may be formed in an area other than an area where the terminal plate is coupled to an electrode tab connected to the electrode assembly.

According to embodiments, the secondary battery may include a protective tape covering at least part of the sealing member or the degassing passage.

According to embodiments, the protective tape may be attached to the sealing member after a needle for degassing gas inside the secondary battery is inserted into and separated from the degassing passage.

According to embodiments of the present disclosure, there is provided a secondary battery, including a case accommodating an electrode assembly inserted through an opening formed on one side and including a vent hole penetrating one surface of the case, a cap assembly sealing the opening of the case, and a sealing member inserted into the vent hole and including a degassing passage penetrated in a first direction.

According to embodiments, the case may include a sidewall portion including the opening on one side, and a bottom portion connected to the sidewall portion, and the one surface of the case in which the vent hole is formed may be the bottom portion.

According to embodiments of the present disclosure, there is provided a manufacturing method of a secondary battery, the method including inserting a sealing member into a vent hole formed by penetrating a cap assembly in a first direction, inserting an electrode assembly into the case through an opening formed on one side of a case, sealing the case by seating the cap assembly, into which the sealing member is inserted, at the opening, and inserting a needle into the sealing member and degassing gas inside the case through the needle.

According to embodiments, the method may further include separating the needle from the sealing member and attaching a protective tape to the sealing member.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 is a cross-sectional view illustrating a secondary battery according to embodiments;

FIG. 2 is a cross-sectional view illustrating a cap assembly, a sealing member, and an insulating washer according to embodiments;

FIG. 3 is a flow chart illustrating an example of a manufacturing method of a secondary battery according to embodiments;

FIG. 4 is a cross-sectional view illustrating a cap assembly according to embodiments;

FIG. 5 is a cross-sectional view illustrating a cap assembly according to embodiments;

FIG. 6 is a cross-sectional view illustrating a cap assembly into which a sealing member is inserted according to embodiments;

FIG. 7 is a cross-sectional view illustrating a cap assembly to which an insulating washer is attached according to embodiments;

FIG. 8 is a cross-sectional view illustrating a cap assembly into which a needle is inserted according to embodiments;

FIG. 9 is a cross-sectional view illustrating a cap assembly to which a protective tape is attached according to embodiments;

FIG. 10 is a cross-sectional view illustrating a secondary battery according to embodiments;

FIG. 11 is a cross-sectional view illustrating a secondary battery according to embodiments; and

FIG. 12 is a cross-sectional view illustrating a secondary battery according to embodiments.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

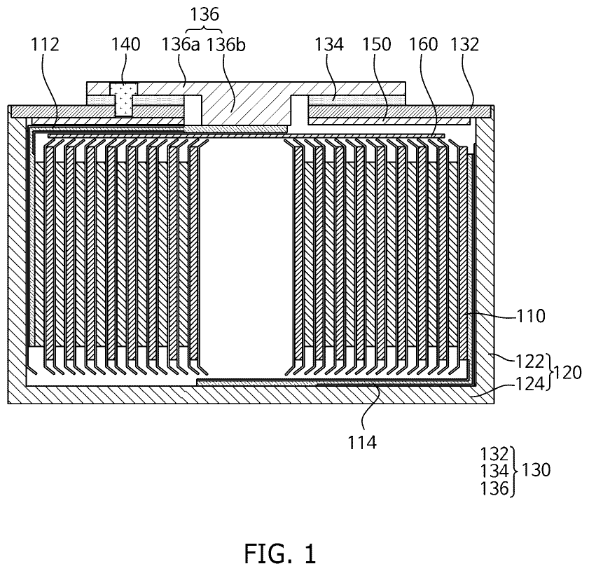

FIG. 1 is a cross-sectional view illustrating a secondary battery according to embodiments. FIG. 1 is a cross-sectional view illustrating the structure of a secondary battery, which is cut along the line across the center of the cylindrical-shaped secondary battery in a height direction. The secondary battery may include an electrode assembly 110, a case 120, a cap assembly 130, a sealing member 140, an insulating washer 150, and an insulating member 160.

According to embodiments, the secondary battery may be coin-shaped or button shaped. For example, the secondary battery may have a cylindrical shape. In another example, the secondary battery may have a square shape or a pouch-shape.

The electrode assembly 110 may include a first electrode, a second electrode, and a separator. The electrode assembly 110 may be formed by winding the first electrode, the second electrode, and the separator disposed between the first electrode and the second electrode. For example, the electrode assembly 110 may be wound to form a winding portion, and may include a winding hole in the winding portion. In another example, the electrode assembly 110 may be a stack-type rather than a winding type. In yet another example, the electrode assembly 100 may be a Z-stack electrode assembly in which the first electrode and the second electrode are inserted on both sides of the separator folded in a Z-stack.

The first electrode may include a first substrate, and a first combining portion disposed on the first substrate. A first electrode tab 112 may extend outwardly from a first non-coated unit, in which the first combining portion is not disposed, of the first substrate, and the first electrode tab 112 may be electrically connected to a terminal plate 136 of the cap assembly 130.

A second electrode may include a second substrate, and a second combining portion disposed on the second substrate. A second electrode tab 114 may extend outwardly from a second non-coated unit, in which the second combining portion is not disposed, of the second substrate, and the second electrode tab 114 may be electrically connected to the case 120.

According to embodiments, each of the first electrode tab 112 and the second electrode tab 114 may be covered by a cover tape. The cover tape may include an insulating material. The cover tape may provide electrical insulation so that a current may not pass. A short circuit may be prevented from the first electrode tab 112 and the second electrode tab 114 by the cover tape.

The first electrode may function as an anode. In this case, the first substrate may be formed of, e.g., aluminum foil, and the combining portion may include, e.g., a transition metal oxide. The second electrode may function as a cathode. In this case, the second substrate may be formed of, e.g., copper foil or nickel foil, and a second active material layer may include, e.g., graphite.

The separator may prevent short circuits of the first electrode and the second electrode while allowing the movement of lithium ions. The separator may be formed of, e.g., a polyethylene film, a polypropylene film, a polyethylene-polypropylene film, etc.

For example, referring to FIG. 1, the first electrode tab 112 of the first electrode may be formed on one side of the electrode assembly 110, and the second electrode tab 114 of the second electrode may be formed on the other side of the electrode assembly 110. In another example, the first electrode tab and the second electrode tab may be formed on one side of the electrode assembly 110.

The case 120 may accommodate the electrode assembly 110 and an electrolyte to form the outer shape of the secondary battery with the cap assembly 130. The case 120 may include a sidewall portion 122 in a cylinder shape, and a bottom portion 124 connected to one side of the sidewall portion 122. An opening for inserting the electrode assembly 110 may be formed on the other side of the sidewall portion 122. The shape of the case 120 may have various shapes such as a cylindrical shape, a pouch shape, etc. The case 120 may be made of a metal, e.g., aluminum, aluminum alloy, nickel-plated steel, steel use stainless (SUS), or a laminate film or plastic that constitutes the pouch.

The electrode assembly 110 may be inserted into the case 120 through the opening formed on one side thereof. The cap assembly 130 may be seated at the opening of the case 120 and coupled to the one side of the case 120.

The cap assembly 130 may include a cap plate 132, an insulating layer 134, and the terminal plate 136. The cap plate 132 may cover the opening of the case 120. The cap plate 132 may be coupled to one side of the case 120 corresponding to a side surface of the opening. For example, the cap plate 132 may be coupled to the case 120 engaged with a step difference formed on the upper side of the sidewall portion 122 of the case 120.

According to embodiments, a through-hole may be formed in the cap plate 132. For example, the through-hole may be formed in the center of the cap plate 132. The terminal plate 136 may be inserted into the through-hole so that the terminal plate 136 may be coupled to the cap plate 132. The terminal plate 136 may include a body portion 136a and an insertion portion 136b protruding from the body portion 136a. The insertion portion 136b of the terminal plate 136 may be inserted into the through-hole of the cap plate 132. The insertion portion 136b of the terminal plate 136 may be connected to the first electrode tab 112. Referring to FIG. 1, the cap assembly 130 including the terminal plate 136 may be coupled to the case 120 so that the insertion portion 136b may face the electrode assembly.

The insulating layer 134 may be disposed between the terminal plate 136 and the cap plate 132. The insulating layer 134 may include adhesion that connects the terminal plate 136 to the cap plate 132. The insulating layer 134 may be formed of an insulating layer to electrically insulate between the terminal plate 136 and the cap plate 132.

According to embodiments, an insulating washer 150 may be placed on a surface of the cap assembly 130 facing the electrode assembly 110. Referring to FIG. 1, the insulating washer 150 may be disposed on the bottom of the cap plate 132. The top of the cap plate 132 may face the body portion 136a of the terminal plate 136, and the bottom of the cap plate 132 may face the electrode assembly 110. The insulating washer 150 may be formed of an insulating material to insulate between the cap plate 132 and the electrode assembly 110 or between the cap plate 132 and the first electrode tab 112.

According to embodiments, the insulating member 160 may be disposed between the first electrode tab 112 placed under the terminal plate 136 and the electrode assembly 110. The insulating member 160 may include an insulating material. The insulating member 160 may separate the first electrode tab 112 and the electrode assembly 110. The insulating member 160 may electrically insulate between the first electrode tab 112 and the electrode assembly 110.

The cap assembly 130 may include a vent hole penetrating the cap assembly 130 in a first direction. The first direction may be a height direction of the cap assembly 130, e.g., a direction parallel to a direction from the cap assembly 130 toward the bottom portion 124 of the case 120.

The sealing member 140 may be included in the vent hole of the cap assembly 130. The sealing member 140 may include a degassing passage penetrated in a second direction. The second direction may be a height direction of the sealing member 140. For example, referring to FIG. 1, the first direction and the second direction may be parallel.

According to embodiments, the sealing member 140 may be greater than the vent hole of the cap assembly 130, e.g., a width of a portion of the sealing member 140 inserted into the vent hole may be larger than a width of the vent hole. The sealing member 140 may be formed of an elastic material, pressurized, and inserted into the vent hole. The sealing member 140 may expand in the vent hole to be inserted in close contact (e.g., direct contact) with the inner diameter of the vent hole (e.g., the pressurized sealing member 140 may expand within the vent hole to directly contact and press against the inner diameter of the vent hole).

According to embodiments, a needle may be inserted through the degassing passage of the sealing member 140. The gas inside the second battery may be discharged through the inserted needle. The electrolyte may be injected (e.g., injectable) into the secondary battery through the inserted needle. The gas may be discharged or the electrolyte may be injected according to the environment inside the secondary battery by inserting the needle into the degassing passage of the sealing member 140. The degassing passage may be formed by inserting the needle into the sealing member 140.

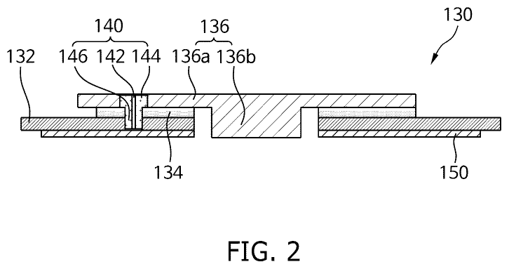

FIG. 2 is an enlarged cross-sectional view of the cap assembly 130, the sealing member 140, and the insulating washer 150, according to embodiments. In FIG. 2, description of configurations described previously with reference to FIG. 1 will be omitted, and the description below will focus on the sealing member 140 in detail.

Referring to FIG. 2, according to embodiments, the sealing member 140 may include a degassing passage 142 penetrating in the second direction (e.g., in the height direction of the sealing member 140). For example, referring to FIG. 2, the degassing passage 142 may be a hole (e.g., a channel) penetrating inside the sealing member 140, e.g., the degassing passage 142 may extend continuously along an entire height of the sealing member 140. In another example, the degassing passage 142 may be sealed by the elasticity of the sealing member 140. Unless a component such as a needle is inserted into the degassing passage 142, the fluid inside the secondary battery (e.g., electrolyte, gas, etc.) may leak to the outside, or the fluid outside the secondary battery (e.g., air, etc.) may not flow in.

For another example, the degassing passage 142 may not be formed in an initial sealing member. The initial sealing member may be inserted into the vent hole of the cap assembly 130, and a component, e.g., a needle, may be inserted through the initial sealing member. The degassing passage 142 may be formed in the sealing member 140 by the needle penetrating the initial sealing member. The degassing passage 142 may be sealed due to the elasticity of the sealing member 140 after the needle is removed.

According to embodiments, the insulating washer 150 may cover the vent hole. Referring to FIG. 2, the insulating washer 150 may cover a surface of the vent hole. The insulating washer 150 may aid in blocking the interior of the secondary battery from the outside by covering the vent hole.

According to embodiments, the sealing member 140 may include a head portion 144 and a tail portion 146. The sealing member 140 may be inserted into the vent hole of the cap assembly 130 so that the tail portion may be oriented downward. The downward indicates the tail portion may face in the direction of the electrode assembly.

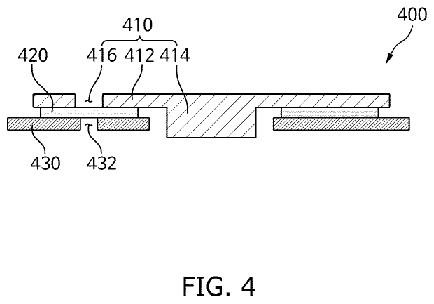

According to embodiments, the diameter of the head portion 144 may be larger than that of the tail portion 146. The inner diameter of the vent hole into which the sealing member 140 is inserted may vary depending on height. The head portion 144 may be seated in a part of the cap assembly 130 corresponding to the inner diameter of the vent hole. The structure of the vent hole will be described referring to FIG. 4 to FIG. 6.

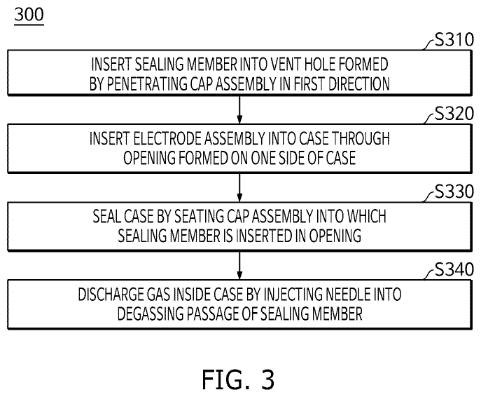

FIG. 3 is an exemplary flow chart illustrating a manufacturing method 300 of a secondary battery according to embodiments. The manufacturing method 300 of the secondary battery may be performed by a secondary battery manufacturing apparatus. The secondary battery manufacturing apparatus may include a needle.

The manufacturing method of the secondary battery may be performed by inserting a sealing member into the vent hole formed by penetrating the cap assembly in the first direction (S310). The sealing member may be formed of an elastic material, and inserted in close contact with the inner diameter of the vent hole.

According to embodiments, the cap assembly may be seated and coupled to the opening of the case, and may include a cap plate in which a through-hole is formed, a terminal plate including a body portion and an insertion portion protruding from the body portion to be inserted into the through-hole of the cap plate, and an insulating layer disposed between the cap plate and the terminal plate. The insulating washer may be disposed on a surface of the cap assembly facing the electrode assembly. The insulating washer may cover the vent hole.

According to embodiments, the vent hole may include a first sub-vent hole penetrating a terminal plate, a second sub-vent hole penetrating a cap plate, and a third sub-vent hole penetrating an insulating layer.

According to embodiments, the terminal plate may be coupled to the cap plate so that the insertion portion may face the electrode assembly. The diameter of the first sub-vent hole may be larger than the diameter of the second sub-vent hole and the diameter of the third sub-vent hole. The sealing member may include a head portion formed of a first diameter larger than at least one of the diameter of the second sub-vent hole or the diameter of the third sub-vent hole, and a tail portion formed of a second diameter smaller than the first diameter, and the head portion may be seated in at least one of the insulating layer and the cap plate.

According to embodiments, the terminal plate may be coupled to the cap plate so that the insertion portion may be exposed to the outside through the through-hole of the cap plate, and the body portion may be disposed between the cap plate and the electrode assembly. The case may accommodate the electrolyte with the electrode assembly. The diameter of the second sub-vent hole may be larger than those of the first sub-vent hole and the third sub-vent hole. The sealing member may include a head portion formed of a third diameter larger than at least one of the diameter of the first sub-vent hole or the diameter of the third sub-vent hole, and a tail portion formed of a fourth diameter smaller than the third diameter, and the head portion may be seated in at least one of the insulating layer or the terminal plate.

According to embodiments, the vent hole may be formed by penetrating the body portion and the insertion portion of the terminal plate. The vent hole may be formed in other areas of the terminal plate than the area where it is coupled to the electrode tab connected to the electrode assembly.

According to embodiments, in the secondary battery manufacturing apparatus, the electrode assembly may be inserted into the case through the opening formed on one side of the case (S320).

According to embodiments, the secondary battery manufacturing apparatus may seal the case by placing the cap assembly, into which the sealing member is inserted, in the opening (S330). The case sealed by the cap assembly and accommodating the electrolyte and the electrode assembly may function as a battery. Such batteries may generate gas inside the case due to a predetermined charging and discharging process (e.g., a lithiation process).

According to embodiments, the secondary battery manufacturing apparatus may discharge the gas inside the case by inserting the needle into the sealing member (S340). The needle may include an outlet on the inside through which gas flows inside. The gas inside the case may be discharged to the outside through the outlet of the needle.

According to embodiments, the secondary battery manufacturing apparatus may separate the needle from the sealing member and attach a protective tape on the sealing member. The protective tape may cover at least part of the sealing member and the degassing passage.

In the manufacturing process of the secondary battery, a predetermined charging and discharging process (e.g., a lithiation process) may be performed. In this case, gas may be generated inside the secondary battery, so that the secondary battery (e.g., a coin-shaped secondary battery) may need the configuration for degassing gas. According to embodiments of the present disclosure, the gas inside the secondary battery may be removed by inserting the needle through the degassing passage of the sealing member inserted into the vent hole. Therefore, the increase in electrical resistance of the secondary battery may be suppressed due to gas inside the secondary battery, and safety accidents possibly caused by gas may be prevented.

The flow chart and description of FIG. 3 is exemplary only. For example, one or more of steps of the flowchart and the description may be added, changed, or deleted. In another example, one or more steps may be performed concurrently.

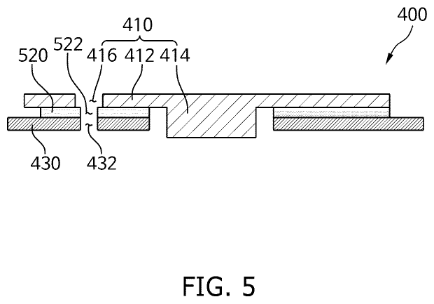

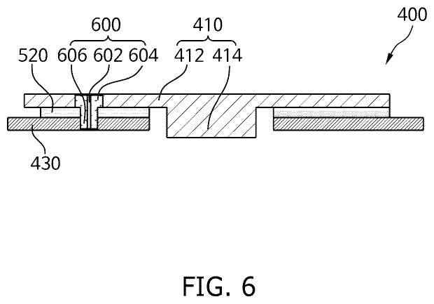

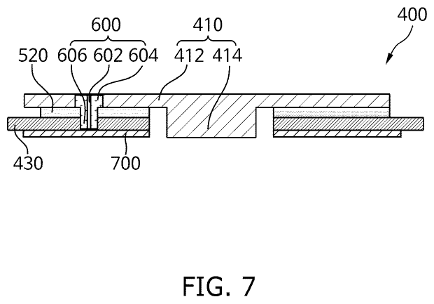

FIG. 4 is a cross-sectional view of a cap assembly 400 according to embodiments. FIG. 5 is a cross-sectional view of a cap assembly 400 according to embodiments. FIG. 6 is a cross-sectional view of the cap assembly 400 into which a sealing member 600 is inserted according to embodiments. FIG. 7 is a cross-sectional of the cap assembly 400 into which an insulating washer 7000 is attached according to embodiments. FIG. 4 to FIG. 7 illustrate stages in the manufacturing process of the cap assembly 400 into which the sealing member 600 is inserted.

Referring to FIG. 4, a through-hole may be formed in the center of the cap plate 430. The terminal plate 410 may include a body portion 412 and an insertion portion 414 protruding from the body portion 412. The insertion portion 414 may be inserted into the through-hole of the cap plate 430.

According to embodiments, a pre-processed insulating layer 420 may be formed between the cap plate 430 and the body portion 412 of the terminal plate 410. The pre-processed insulating layer 420 may have adhesion to connect the cap plate 430 to the terminal plate 410. Additionally or alternatively, the pre-processed insulating layer 420 may be formed of resin and heat-pressurized between the cap plate 430 and the terminal plate 410, so that the cap plate 430 and the terminal plate 410 may be coupled to each other.

According to embodiments, the terminal plate 410 may include a first sub-vent hole 416 penetrating the terminal plate 410. The cap plate 430 may include a second sub-vent hole 432 penetrating the cap plate 430. The terminal plate 410 may be coupled to the cap plate 430 such that the first sub-vent hole 416 of the terminal plate 410 may face the second sub-vent hole 432 of the cap plate 430, e.g., the first sub-vent hole 416 and the second sub-vent hole 432 may be aligned and vertically overlap each other.

Referring to FIG. 5, the third sub-vent hole 522 may be formed in the insulating layer 520 by processing the insulating layer. The third sub-vent hole 522 may face the first sub-vent hole 416 and the second sub-vent hole 432. The diameter of the first sub-vent hole 416 may be larger than those of the second sub-vent hole 432 and the third sub-vent hole 522, e.g., diameters of the second sub-vent hole 432 and the third sub-vent hole 522 may equal each other. The vent hole of the cap assembly 400 may include the first sub-vent hole 416, the second sub-vent hole 432, and the third sub-vent hole 522, e.g., the first sub-vent hole 416, the second sub-vent hole 432, and the third sub-vent hole 522 may vertically overlap each other.

Referring to FIG. 6, a sealing member 600 may be inserted into the vent hole of the cap assembly 400. The sealing member 600 may include a head portion 604, a tail portion 606, and a degassing passage 602 penetrating the head portion 604 and the tail portion 606. The head portion 604 may be formed of a first diameter, and the tail portion 606 may be formed of a second diameter smaller than the first diameter.

According to embodiments, the first diameter may be larger than the diameter of the second sub-vent hole of the cap plate 430 or the diameter of the third sub-vent hole of the insulating layer 520. The head portion 604 may be seated in at least one of the insulating layer 520 or the cap plate 430. The head portion 604 may inserted in close contact with the inner diameter of the first sub-vent hole 416 of the terminal plate 410, and the tail portion 606 may be inserted in close contact with the inner diameter of the second sub-vent hole 432 of the cap plate 430 and/or the inner diameter of the third sub-vent hole 522 of the insulating layer 520.

Referring to FIG. 7, an insulating washer 700 may be disposed on the cap assembly 400 into which the sealing member 600 is inserted. For example, the insulating washer 700 may be attached to the bottom of the cap plate 430. The insulating washer 700 may cover a surface of the vent hole and/or the sealing member 600.

The cap assembly 400, which includes the inserted sealing member 600 and the attached insulating washer 700, may be seated on a side of the case of the secondary battery. The case may be sealed by welding the area of the cap assembly 400 that is in contact with the case.

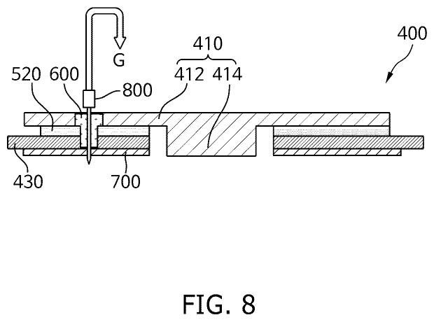

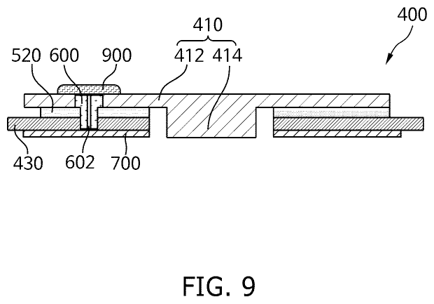

FIG. 8 is a cross-sectional view of the cap assembly 400 into which a needle 800 is inserted according to embodiments. FIG. 9 is a cross-sectional view of the cap assembly 400 to which a protective tape 900 is attached (e.g., attachable) according to embodiments. Referring to FIG. 8 and FIG. 9, it is assumed that the cap assembly 400 with the sealing member 600 inserted and the insulating washer 700 attached may be coupled to the case that accumulates the electrode assembly and the electrolyte.

Referring to FIG. 8, the needle 800 may be inserted into the degassing passage of the sealing member 600. The needle 800 may penetrate the insulating washer 700 to connect the inside and the outside of the secondary battery. For example, the electrolyte may flow inside the secondary battery from the outside through the needle 800, and gas G may flow out of the secondary battery to the outside.

According to embodiments, the gas G may be generated as the electrode assembly is impregnated with the electrolyte inside the secondary battery. As the secondary battery is charged and discharged, the gas G may be generated inside the secondary battery. The needle 800 may be inserted into the degassing passage of the sealing member 600. The gas G inside the secondary battery may be discharged through the inserted needle 800.

According to embodiments, the electrolyte may be insufficient inside the secondary battery. In this case, the electrolyte may be injected into the secondary battery through the needle 800 by inserting the needle 800 into the degassing passage.

Referring to FIG. 9, after being inserted into the degassing passage 602, the needle may be separated from the sealing member 600. The protective tape 900 may be attached to the cap assembly 400. The protective tape 900 may cover at least part of the sealing member 600 and the degassing passage 602.

According to embodiments, due to the elasticity of the sealing member 600, the sealing member 600 may expand to the degassing passage 602 through which the needle passes. Due to this, the degassing passage 602 may be blocked by the sealing member 600 itself. In addition, the protective tape 900 may cover the degassing passage 602 so that the degassing passage 602 may be doubly protected.

The protective tape 900 may be formed of a waterproof material. The protective tape 900 may prevent fluids outside the secondary battery from flowing in through the degassing passage 602.

The needle may be separated after penetrating the insulating washer 700. The insulating washer 700 may be formed of an elastic material or of a viscous material so that a hole may not be formed in the area through which the needle penetrates. The insulating washer 700 penetrated by the needle may cover the vent hole and/or the sealing member 600.

Although the needle is inserted by penetrating the degassing passage 602 of the sealing member 600, and is separated from the sealing member 600, the sealing member 600, the insulating washer 700 and/or the protective tape 900 may protect the degassing passage 602 and/or the vent hole, so that impurities may not flow into the inside the secondary battery through the degassing passage 602 and/or the vent hole, or partial configuration inside the secondary battery may not be discharged.

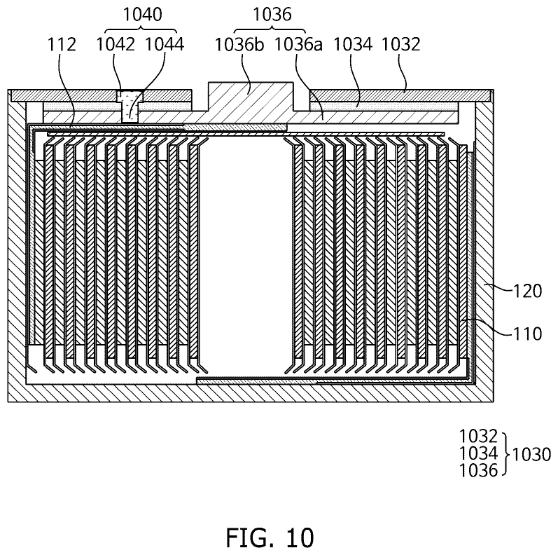

FIG. 10 is a cross-sectional view of a secondary battery according to embodiments. The secondary battery described in FIG. 10 may include the same configurations as in the secondary battery described referring to FIG. 1, other than a cap assembly 1030 and a sealing member 1040. In FIG. 10, descriptions of same elements described previously with reference to FIG. 1 will be omitted, and the following description will focus on the cap assembly 1030 and the sealing member 1040 in detail.

Referring to FIG. 10, the cap assembly 1030 may be seated and coupled to the opening of the case 120 and may include a cap plate 1032 in which a through-hole is formed, a terminal plate 1036 including a body portion 1036a and an insertion portion 1036b protruding from the body portion 1036a and inserted into the through-hole of the cap plate 1032, and an insulating layer 1034 disposed between the cap plate 1032 and the terminal plate 1036. The terminal plate 1036 may be coupled to the cap plate 1032 so that the insertion portion 1036b may be exposed to the outside through the through-hole of the cap plate 1032. The body portion 1036a of the terminal plate 1036 may be disposed between the cap plate 1032 and the electrode assembly 110. The first electrode tab 112 connected to the first electrode of the electrode assembly 110 may be electrically connected to the body portion 1036a of the terminal plate 1036.

According to embodiments, an insulating washer may be disposed on a surface of the cap assembly 1030 facing the electrode assembly 110. For example, the body portion 1036a of the terminal plate 1036 may face the electrode assembly 110, and the insertion portion 1036b may be disposed toward the outside of the secondary battery. The insulating washer may be disposed on the bottom of the body portion 1036a. The lower part of the body portion 1036a may be a surface of the body portion 1036a facing the electrode assembly 110. The insulating washer may insulate between the first electrode tab 112 and/or the electrode assembly 110 and the terminal plate 1036.

The cap assembly 1030 may include a vent hole penetrating the cap assembly 1030 in the first direction (e.g., the height direction of the secondary battery). The vent hole may include a first sub-vent hole penetrating the terminal plate 1036, a second sub-vent hole penetrating the cap plate 1032, and a third sub-vent hole penetrating an insulating layer 1034.

According to embodiments, the sealing member 1040 may include a head portion 1042 formed of a first diameter, and a tail portion 1044 formed of a second diameter smaller than the first diameter. The sealing member 1040 may be inserted into the vent hole of the cap assembly 1030 so that the tail portion 1044 of the sealing member 1040 may face the electrode assembly 110.

The diameter of the second sub-vent hole of the cap plate 1032 may be larger than the diameter of the first sub-vent hole of the terminal plate 1036 and the diameter of the third sub-vent hole of the insulating layer 1034. The first diameter of the head portion 1042 may be larger than at least one of the diameter of the first sub-vent hole or the diameter of the third sub-vent hole. The sealing member 1040 inserted into the vent hole may be seated in at least one of the insulating layer 1034 or the terminal plate 1036.

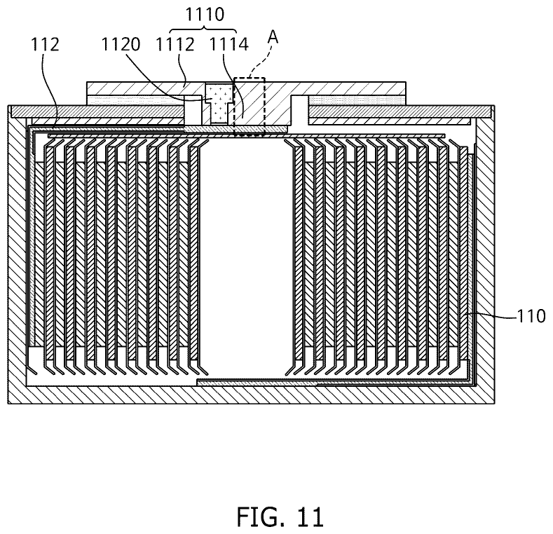

FIG. 11 is a cross-sectional view of a secondary battery according to embodiments. The secondary battery in FIG. 11 may include the same configurations in the secondary battery described in FIG. 1, except for the terminal plate 136 and the sealing member 140. The descriptions of same elements as described previously with reference to FIG. 1 will be omitted, and the following description will focus on a terminal plate 1110 and a sealing member 1120 in detail.

Referring to FIG. 1, the terminal plate 1110 may include a body portion 1112 and an insertion portion 1114 protruding from the body portion 1112 and inserted into the through-hole of the cap plate. The vent hole penetrating the cap assembly in the first direction may be formed in the terminal plate 1110. The vent hole may be formed by penetrating the body portion 1112 and the insertion portion 1114 of the terminal plate 1110. The sealing member 1120 may be inserted into the vent hole. The vent hole may be formed to correspond to, e.g., visually resemble, the outer shape of the sealing member 1120.

The terminal plate 1110 may be coupled to the first electrode tab 112 connected to the first electrode of the electrode assembly 110 (e.g., coupling by welding). By welding the terminal plate 1110 on the outside of the secondary battery, the terminal plate 1110 and the first electrode tab 112 may be coupled to each other. Referring to FIG. 11, the terminal plate 1110 may be coupled to the first electrode tab 112 in a coupling area A.

The vent hole may be formed in areas other than the area where the terminal plate 1110 is coupled to the first electrode tab 112 (e.g., the coupling area (A) of FIG. 11). The terminal plate 1110 may be easily coupled to the first electrode tab 112.

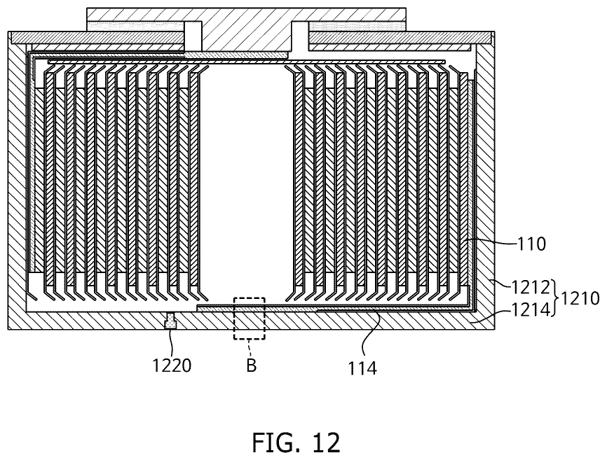

FIG. 12 is a cross-sectional view of the secondary battery according to embodiments. The secondary battery in FIG. 12 may include the same configurations in the secondary battery described in FIG. 1, except for the case 120 and the sealing member 140. The descriptions of same elements as described previously with reference to FIG. 1 will be omitted, and the following description will focus on a case 1210 and a sealing member 1220 in detail.

Referring to FIG. 12, the case 1210 may accommodate the electrode assembly 110 and an electrolyte to form the outer shape of the secondary battery with the cap assembly. The case 1210 may include a sidewall portion 1212 and a bottom portion 1214 connected to the sidewall portion 1212. An opening may be formed for inserting the electrode assembly 110 on the other side of the sidewall portion 1212. The opening of the sidewall portion 1212 may be sealed by the cap assembly.

The vent hole may be formed by penetrating one surface of the case 1210. For example, the vent hole may be formed in the bottom portion 1214 of the case 1210. The sealing member 1220 may be inserted into the vent hole. The tail portion of the sealing member 1220 may be inserted into the vent hole to face the electrode assembly 110.

The sealing member 1220 may include a degassing passage penetrated in the first direction. The first direction may correspond to the direction penetrating one surface of the case 1210.

The bottom portion 1214 may be coupled to the second electrode tab 114 connected to the second electrode of the electrode assembly 110 (e.g., coupled by welding). By welding the bottom portion 1214 and the second electrode tab 114, the bottom portion 1214 may be coupled to the second electrode tab 114. Referring to FIG. 12, the bottom portion 1214 may be coupled to the second electrode tab 114 in a coupling portion B.

The vent hole may be formed in areas other than the area where the bottom portion 1214 is coupled to the second electrode tab 114 (e.g., the coupling area (B) of FIG. 12). The bottom portion 1214 may be easily coupled to the second electrode tab 114.

By way of summation and review, the present disclosure provides a secondary battery and a manufacturing method thereof that facilitates deassing of the secondary battery. That is, according to embodiments, the gas inside the secondary battery may be removed by inserting a needle through a degassing passage of a sealing member inserted into a vent hole. Therefore, the increase in electrical resistance of the secondary battery may be suppressed by the gas inside the secondary battery, and safety accidents possibly caused by gas may be prevented or substantially minimized.

According to embodiments, although the needle is inserted by penetrating the degassing passage of the sealing member and separated from the sealing member, the sealing member, the insulating washer, and/or the protective tape may increase protection of the degassing passage and/or the vent hole. Therefore, impurities may not flow into the interior of the secondary battery or partial configurations inside the secondary battery may not flow out to the outside through the degassing passage and/or the vent hole.

According to embodiments, the vent hole may be formed in areas other than the area where the terminal plate is coupled to the first electrode tab. Therefore, the terminal plate may be easily coupled to the first electrode tab.

According to embodiments, the vent hole may be formed in areas other than the area where the bottom portion is coupled to the second electrode tab. Therefore, the bottom portion may be easily coupled to the second electrode tab.

However, aspects and features of the present disclosure are not limited to those described above, and other aspects and features not mentioned will be clearly understood by a person skilled in the art from the detailed description, described above.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A secondary battery, comprising:
an electrode assembly;
a case accommodating the electrode assembly, the case including an opening on one side thereof,
a cap assembly seated in the opening of the case, the cap assembly including a vent hole penetrating the cap assembly in a first direction; and
a sealing member in the vent hole, the sealing member including a degassing passage in the first direction.

2. The secondary battery as claimed in claim 1, further comprising an electrolyte in the case, the electrolyte being injectable through the degassing passage.

3. The secondary battery as claimed in claim 1, wherein the sealing member includes an elastic material, the sealing member being in close contact with an inner diameter of the vent hole.

4. The secondary battery as claimed in claim 1, wherein the cap assembly includes:
a cap plate seated in and coupled to the opening of the case, the cap plate including a through-hole;
a terminal plate including a body portion and an insertion portion protruding from the body portion, the insertion portion being inserted into the through-hole of the cap plate; and
an insulating layer between the cap plate and the terminal plate.

5. The secondary battery as claimed in claim 4, further comprising an insulating washer on one surface of the cap assembly facing the electrode assembly, the insulating washer covering the vent hole.

6. The secondary battery as claimed in claim 4, wherein the vent hole includes:
a first sub-vent hole through the terminal plate;
a second sub-vent hole through the cap plate; and
a third sub-vent hole through the insulating layer.

7. The secondary battery as claimed in claim 6, wherein the terminal plate is coupled to the cap plate such that the insertion portion faces the electrode assembly.

8. The secondary battery as claimed in claim 7, wherein a diameter of the first sub-vent hole is larger than a diameter of the second sub-vent hole and a diameter of the third sub-vent hole.

9. The secondary battery as claimed in claim 8, wherein:
the sealing member includes a head portion having a first diameter larger than a diameter of the second sub-vent hole and a diameter of the third sub-vent hole, and a tail portion having a second diameter smaller than the first diameter, and
the head portion is seated on at least one of the insulating layer and the cap plate.

10. The secondary battery as claimed in claim 6, wherein:
the terminal plate is coupled to the cap plate such that the insertion portion is exposed to an outside through the through-hole of the cap plate, and
the body portion is between the cap plate and the electrode assembly.

11. The secondary battery as claimed in claim 10, wherein a diameter of the second sub-vent hole is larger than a diameter of the first sub-vent hole and a diameter of the third sub-vent hole.

12. The secondary battery as claimed in claim 11, wherein:
the sealing member includes a head portion having a third diameter larger than a diameter of the first sub-vent hole or a diameter of the third sub-vent hole, and a tail portion having a fourth diameter smaller than the third diameter, and
the head portion is seated on at least one of the insulating layer and the terminal plate.

13. The secondary battery as claimed in claim 5, wherein the vent hole penetrates the body portion and the insertion portion.

14. The secondary battery as claimed in claim 13, wherein the vent hole is in an area other than an area where the terminal plate is coupled to an electrode tab connected to the electrode assembly.

15. The secondary battery as claimed in claim 1, further comprising a protective tape covering the degassing passage and at least part of the sealing member.

16. The secondary battery as claimed in claim 15, wherein the protective tape is attachable to the sealing member after degassing.

17. A secondary battery, comprising:
an electrode assembly;
a case accommodating the electrode assembly, the case including an opening on one side thereof and a vent hole penetrating one surface of the case;
a cap assembly sealing the opening of the case; and
a sealing member in the vent hole, the sealing member including a degassing passage in a first direction.

18. The secondary battery as claimed in claim 17, wherein:
the case includes a sidewall portion including the opening on one side, and a bottom portion connected to the sidewall portion, and
the one surface of the case including the vent hole is in the bottom portion.

19. A manufacturing method of a secondary battery, the method comprising:
inserting a sealing member into a vent hole formed by penetrating a cap assembly in a first direction;
inserting an electrode assembly into a case through an opening formed on one side of the case;
sealing the case by seating the cap assembly, into which the sealing member is inserted, at the opening; and
inserting a needle into the sealing member and degassing gas inside the case through the needle.

20. The method as claimed in claim 19, further including separating the needle from the sealing member and attaching a protective tape to the sealing member.
